(19) United States
(12) Patent Application Publication
(10) Pub. No.: US 2009/0117971 A1
(43) Pub. Date: May 7, 2009

(54) GAMING MACHINE DISPLAYING AREAS CORRESPONDING TO SYMBOLS REARRANGED AND PLAYING METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 11/970,242

(22) Filed: Jan. 7, 2008

Related U.S. Application Data
(60) Provisional application No. 60/984,551, filed on Nov. 1, 2007.

(51) Int. Cl. A63F 13/00

(52) U.S. Cl. 463/20

(57) ABSTRACT

In a bonus game (when a predetermined condition is fulfilled), a first area 191 corresponding to a first symbol 181 rearranged and a second area 192 corresponding to a second symbol 182 rearranged are displayed and a payout is awarded in accordance with a relation between the first area 191 and the second area 192.

### CROSS REFERENCE TO RELATED APPLICATION

This application claims the benefit of U.S. Provisional Application No. 60/984,551, filed on Nov. 1, 2007.

### BACKGROUND OF THE INVENTION

1. Field of the Invention

The invention relates to a slot machine, and a playing method thereof.

2. Description of Related Art

In a conventional slot machine, when a player inserts a game medium such as coin or bill into an insertion slot of the gaming machine and presses a start button, symbols are scroll-displayed in a display mounted on a front of a cabinet and the symbols are then stopped automatically.

In such gaming machine, as disclosed in U.S. Pat. No. 6,604,999 B2 or U.S. Patent No. 2002065124A1, for example, when the symbols stopped on a winning line constitute a predetermined combination, the predetermined numbers of game media are paid out as a win. In addition, when a certain symbol referred to as scatter symbol is displayed on the display, the predetermined number of game media are paid out in accordance with the number of scatter symbols displayed, irrespective of the winning line.

In the conventional slot machines, a bonus game may be executed when a predetermined condition is fulfilled, separately from a base game in which the predetermined number of game media is paid out in accordance with a combination of symbols or the number of scatter symbols. A player should understand a rule so as to determine a situation of whether a payout is awarded in the bonus game.

An object of the invention is to provide a slot machine having an entertainment characteristic, which is not provided to the prior art, and a playing method thereof.

In addition, another object of the invention is to provide a slot machine in which a situation of whether a payout is awarded is visually recognized, and a playing method thereof.

### SUMMARY OF THE INVENTION

A slot machine of the invention comprises: a first display area that arranges a plurality of symbols including a first symbol and a second symbol; a second display area that displays a plurality of areas including a first area corresponding to the first symbol and a second area corresponding to the second symbol; and a controller that is programmed to operate as described in steps of (a1)˜(a4). The controller is programmed (a1) to rearrange the symbols based on a predetermined timing; (a2) to determine a winning by a relation of the symbols rearranged; (a3) to alternately execute an operation of replacing an area, which is not the first area, with the first area, as an area corresponding to a position of the first symbol rearranged, and an operation of replacing an area, which is not the second area, with the second area, as an area corresponding to a position of the second symbol rearranged, whenever the symbols are rearranged; and (a4) to award a prize relating to a relation between the first area and second area displayed, at a specific timing.

According to the above structure, whenever the symbols are rearranged in the first area, an operation of replacing an area, which is not the first area, with the first area, as an area corresponding to a position of the first symbol, and an operation of replacing an area, which is not the second area, with the second area, as an area corresponding to a position of the second symbol are alternately performed in the second display area, and a payout relating to a relation between the first area and second area displayed is awarded at a specific timing. Thereby, it is visually recognized whether a payout is awarded or not by seeing the first area and second area displayed in the second area, so that a new entertainment characteristic can be provided.

A slot machine of the invention comprises: a first display area that arranges a plurality of symbols including a first symbol and a second symbol; a second display area that displays a plurality of areas including a first area corresponding to the first symbol and a second area corresponding to the second symbol; and a controller that is programmed to operate as described in steps of (b1)˜(b4). The controller is programmed (b1) to rearrange the symbols based on a predetermined timing; (b2) to determine a winning by a relation of the symbols rearranged; (b3) when a predetermined condition is fulfilled, to alternately execute an operation of replacing an area, which is not the first area, with the first area, as an area corresponding to a position of the first symbol rearranged, and an operation of replacing an area, which is not the second area, with the second area, as an area corresponding to a position of the second symbol rearranged, whenever the symbols are rearranged; and (b4) to award a prize relating to a relation between the first area and second area displayed, at a specific timing.

According to the above structure, when a predetermined condition is fulfilled, whenever the symbols are rearranged in the first area, an operation of replacing an area, which is not the first area, with the first area, as an area corresponding to a position of the first symbol, and an operation of replacing an area, which is not the second area, with the second area, as an area corresponding to a position of the second symbol are alternately performed in the second display area, and a payout relating to a relation between the first area and second area displayed is awarded at a specific timing. Thereby, it is visually recognized whether a payout is awarded or not by seeing the first area and second area displayed in the second area, so that a new entertainment characteristic can be provided. A slot machine of the invention comprises: a first display area that arranges a plurality of symbols including a first symbol and a second symbol; a second display area that displays a plurality of areas including a first area corresponding to the first symbol and a second area corresponding to the second symbol; a communication device that is in data-communication with the other slot machine; and a controller that is programmed to operate as described in steps of (c1)˜(c4). The controller is programmed (c1) to rearrange the symbols based on a predetermined timing; (c2) to determine a winning by a relation of the symbols rearranged; (c3) to replace an area, which is not the first area, with the first area, as an area corresponding to a position of the first symbol rearranged, to transmit a first symbol position data relating to a position of the first symbol rearranged to the other slot machine, to receive from the other slot machine a second symbol position data relating to a position of the second symbol rearranged in the other slot machine and to replace an area, which is not the second area, with the second area, as an area corresponding to a position based on the second symbol position data, whenever the symbols are rearranged; and (c4) to award a prize relating to a relation between the first area and second area displayed, at a specific timing.

According to the above structure, whenever the symbols are rearranged in the first area, an area, which is not the first area, is replaced with the first area, as an area corresponding to a position of the first symbol rearranged, a first symbol position data relating to a position of the first symbol rearranged is transmitted to the other slot machine, a second symbol position data relating to a position of the second symbol rearranged in the other slot machine is received from the other slot machine and an area, which is not the second area, is replaced with the second area, as an area corresponding to a position based on the second symbol position data, in the second display area. Then, a payout relating to a relation between the first area and second area displayed is awarded at a specific timing. Thereby, it is visually recognized whether a payout is awarded or not by seeing the first area and second area displayed in the second area, so that a new entertainment characteristic can be provided.

A slot machine of the invention comprises: a first display area that arranges a plurality of symbols including a first symbol and a second symbol; a second display area that displays a plurality of areas including a first area corresponding to the first symbol and a second area corresponding to the second symbol; a communication device that is in data-communication with the other slot machine; and a controller that is programmed to operate as described in steps of (d1)˜(d4). The controller is programmed (d1) to rearrange the symbols based on a predetermined timing; (d2) to determine a winning by a relation of the symbols rearranged; (d3) when a predetermined condition is fulfilled, to replace an area, which is not the first area, with the first area, as an area corresponding to a position of the first symbol rearranged, to transmit a first symbol position data relating to a position of the first symbol rearranged to the other slot machine, to receive from the other slot machine a second symbol position data relating to a position of the second symbol rearranged in the other slot machine and to replace an area, which is not the second area, with the second area, as an area corresponding to a position based on the second symbol position data, whenever the symbols are rearranged; and (d4) to award a prize relating to a relation between the first area and second area displayed, at a specific timing.

According to the above structure, when a predetermined condition is fulfilled, whenever the symbols are rearranged in the first area, an area, which is not the first area, is replaced with the first area, as an area corresponding to a position of the first symbol rearranged, a first symbol position data relating to a position of the first symbol rearranged is transmitted to the other slot machine, a second symbol position data relating to a position of the second symbol rearranged in the other slot machine is received from the other slot machine and an area, which is not the second area, is replaced with the second area, as an area corresponding to a position based on the second symbol position data, in the second display area. Then, a payout relating to a relation between the first area and second area displayed is awarded at a specific timing. Thereby, it is visually recognized whether a payout is awarded or not by seeing the first area and second area displayed in the second area, so that a new entertainment characteristic can be provided.

According to the invention, there is provided a playing method of a slot machine using a first display area that arranges a plurality of symbols including a first symbol and a second symbol; and a second display area that displays a plurality of areas including a first area corresponding to the first symbol and a second area corresponding to the second symbol. The playing method comprises the steps of (e1) rearranging the symbols based on a predetermined timing; (e2) determining a winning by a relation of the symbols rearranged; (e3) alternately executing an operation of replacing an area, which is not the first area, with the first area, as an area corresponding to a position of the first symbol rearranged, and an operation of replacing an area, which is not the second area, with the second area, as an area corresponding to a position of the second symbol rearranged, whenever the symbols are rearranged; and (e4) awarding a payout relating to a relation between the first area and second area displayed, at a specific timing.

According to the above structure, whenever the symbols are rearranged in the first area, an operation of replacing an area, which is not the first area, with the first area, as an area corresponding to a position of the first symbol, and an operation of replacing an area, which is not the second area, with the second area, as an area corresponding to a position of the second symbol are alternately performed in the second display area, and a payout relating to a relation between the first area and second area displayed is awarded at a specific timing. Thereby, it is visually recognized whether a payout is awarded or not by seeing the first area and second area displayed in the second area, so that a new entertainment characteristic can be provided.

### BRIEF DESCRIPTION OF THE DRAWINGS

FIG. 1 illustrates a playing method of a slot machine;

FIG. 2 is a block diagram of a slot machine;

FIG. 3 illustrates a display screen in a base game;

FIG. 4 illustrates a display screen in a bonus game;

FIG. 5 illustrates a display screen in a bonus game;

FIG. 6 shows symbols and code numbers thereof;

FIG. 7 shows a network between slot machines;

FIG. 8 is a perspective view showing an external appearance of a slot machine;

FIG. 9 is a block diagram showing an electrical structure of an entire slot machine;

FIG. 10 is a block diagram showing an electrical structure of a sub-control board of a slot machine;

FIG. 11 is a block diagram showing an electrical structure of a server;

FIG. 12 is a flow chart of a game executing process that is performed in a slot machine;

FIG. 13 is a flow chart of a bonus game process that is performed in a slot machine;

FIG. 14 is a flow chart of a bonus game process that is performed in a slot machine;

FIG. 15 is a flow chart of a bonus game process that is performed in a slot machine; and

FIG. 16 is a flow chart of a server processing that is performed in a server.

### DESCRIPTION OF THE PREFERRED EMBODIMENTS

Hereinafter, it will be described an embodiment of a slot machine and a playing method according to the invention.

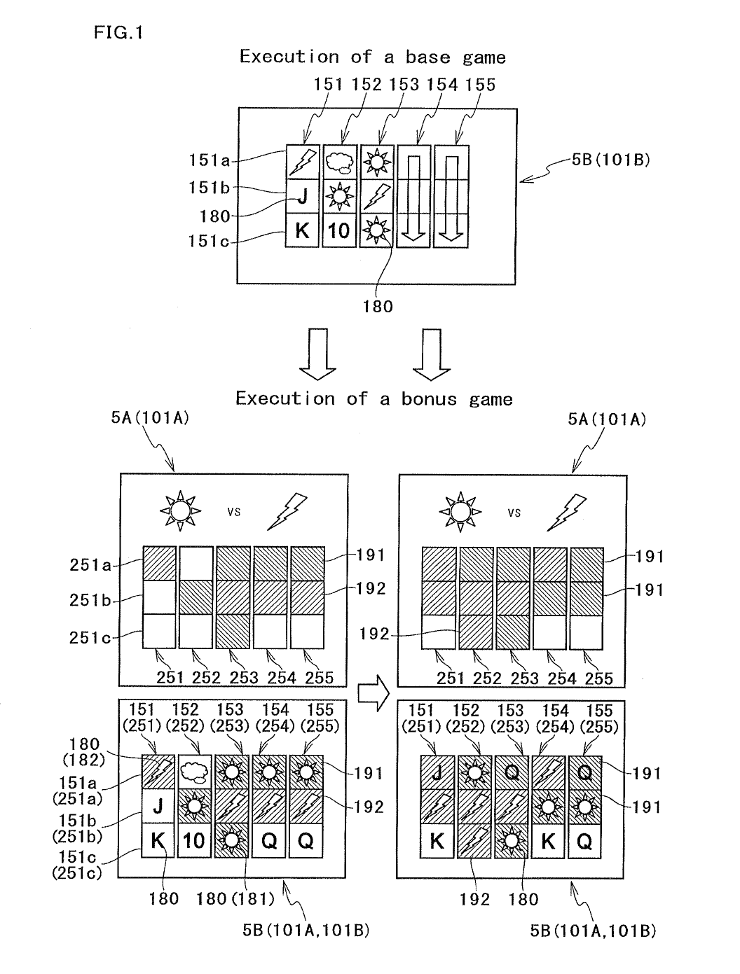

As shown in FIG. 1, a slot machine executes a playing method comprising the steps of: rearranging symbols 180 based on a predetermined timing; determining a winning by a relation of the symbols 180 rearranged; when a predetermined condition is fulfilled, alternately executing an operation of replacing an area, which is not a first area 191, with the first area 191, as an area corresponding to a position of a first symbol 181 rearranged, and an operation of replacing an area, which is not a second area 192, with the second area 192, as an area corresponding to a position of a second symbol 182 rearranged, whenever the symbols 180 are rearranged; when a predetermined condition is fulfilled, replacing an area, which is not the first area 191, with the first area 191, as an area corresponding to a position of the first symbol 181 rearranged, transmitting a first symbol position data relating to a position of the first symbol 181 rearranged to the other slot machine, receiving from the other slot machine a second symbol position data relating to a position of the second symbol 182 rearranged in the other slot machine and replacing an area, which is not the second area 192, with the second area 192, as an area corresponding to a position based on the second symbol position data, whenever the symbols 180 are rearranged; and awarding a payout relating to a relation between the first area 191 and second area 192 displayed, at a specific timing.

Herein, the “arrangement” means a state in which the symbols 180 are allowed to be visible with naked eyes of an exterior player. In other words, in FIG. 1, the symbols 180 are under state of being displayed in the display windows 151˜155 (arrangement area). In the mean time, the “rearrangement” means arranging the symbols 180 again after dismissing the arrangement of the symbols 180. In addition, “when a predetermined condition is fulfilled” means a bonus game. Additionally, the “specific timing” includes a timing at which a winning is determined by a relation of the symbols 180 rearranged in a base game, a timing at which a winning is determined by a relation of the symbols 180 rearranged in a bonus game and an end timing of a bonus game.

(First Display Area 101B and Second Display Area 101A)

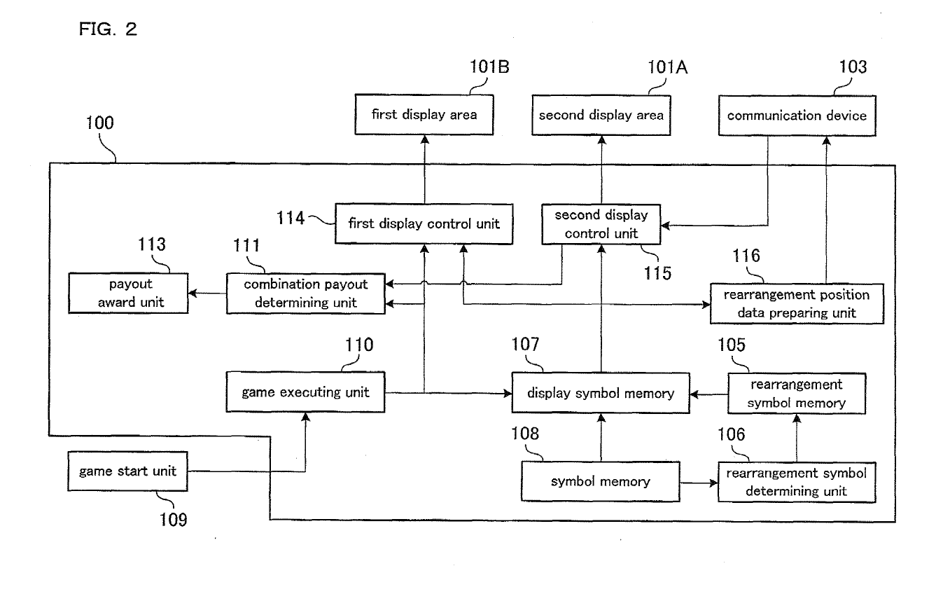

The slot machine that executes the playing method has, as shown in FIG. 2, a first display area 101B, a second display area 101A, a communication device 103 and a controller 100. The first display area 101B is configured to arrange the symbols 180. The symbols 180 include a first symbol 181 and a second symbol 182. The second display area 101A is configured to display a first area 191 corresponding to the first symbol 181 and a second area 192 corresponding to the second symbol 182. To be more specific, the first symbol 181 is a symbol representing “SUN”, the second symbol 182 is a symbol representing “THUNDER”, the first area 191 is a red area and the second area 192 is a blue area. However, it should be noted that they are provided as an example only.

The first display area 101B may be a mechanical structure with a reel device for arranging the symbols 180 by rotation of a reel or electrical structure with a video reel on which an image is displayed for arranging the symbols 180. Further, the first display area 101B may be a structure of combining a mechanical structure (reel) and an electrical structure (video reel). The electrical structure may include a liquid crystal device, a CRT (cathode-ray tube), a plasma display and the like. In addition, the number of the display windows 151˜155 (arrangement area) may be arbitrary. A detailed structure of the first display area 101B will be described later. Likewise the first display area 101B, the second display area 101A may be a mechanical display structure or an electrical structure by an image display.

(Communication Device 103)

The communication device 103 is in data-communication with the other slot machines and transmits/receives position data of the first symbol 181, position data of the second symbol 182, jackpot data and competition party search signal data to and from the other slot machines.

(Controller 100)

The controller 100 is configured to execute a first process of rearranging symbols 180 based on a predetermined timing; a second process of determining a winning by a relation of the symbols 180 rearranged; a third process of, when a predetermined condition is fulfilled, alternately executing an operation of replacing an area, which is not a first area 191, with the first area 191, as an area corresponding to a position of a first symbol 181 rearranged, and an operation of replacing an area, which is not a second area 192, with the second area 192, as an area corresponding to a position of a second symbol 182 rearranged, whenever the symbols 180 are rearranged; a fourth process of, when a predetermined condition is fulfilled, replacing an area, which is not the first area 191, with the first area 191, as an area corresponding to a position of the first symbol 181 rearranged, transmitting a first symbol position data relating to a position of the first symbol 181 rearranged to the other slot machine, receiving from the other slot machine a second symbol position data relating to a position of the second symbol 182 rearranged in the other slot machine and replacing an area, which is not the second area 192, with the second area 192, as an area corresponding to a position based on the second symbol position data, whenever the symbols 180 are rearranged; and a fifth process of awarding a payout relating to a relation between the first area 191 and second area 192 displayed, at a specific timing. In other words, the controller 100 comprises first to fifth processing units.

The controller 100 comprises a symbol memory 108 for storing all symbols 180 and a display symbol memory 107 for storing the symbols 180 in the symbol memory 108 as a display symbol. The display symbol memory 107 can be accessed by a first display control unit 114 and a second display control unit 115. The first display control unit 114 reads out the symbols 180 in the display symbol memory 107 under control of a game executing unit 110 and displays the symbols 180 in the first display area 101B. A detailed display state will be described later.

In addition, the controller 100 comprises a rearrangement symbol determining unit 106 that determines symbols to be rearranged in every unit game, based on the symbols 180 stored in the symbol memory 108. The symbols to be rearranged, which are determined by the rearrangement symbol determining unit 106, are stored in a rearrangement symbol memory 105, are outputted to the display symbol memory 107 and are then used for an image process in the first display control unit 114, so that they are displayed in the first display area 101B.

Furthermore, the controller 100 is associated with a game start unit 109. The game start unit 109 has a function of outputting a game start signal by an operation of the player. The controller 100 comprises a game executing unit 110 for executing a unit game in which the symbols 180 are rearranged, a combination payout determining unit 111 for determining a payout in a unit game, and a payout award unit 113 for awarding the payout determined in the combination payout determining unit 111.

The game executing unit 110 starts, based on a predetermined timing, a variable display of the symbols 180 arranged in the first display area 101B with a game start signal, as trigger, from the game start unit 109 and rearranges the symbols 180 in a timing at which a predetermined time has elapsed after the variable display is started. In other words, the controller 100 executes a first process of rearranging the symbols 180 based on a predetermined timing. The combination payout determining unit 111 determines a payout that is determined by a combination of the symbols 180 rearranged in a unit game. In other words, the controller 100 executes a second process of determining a winning on the basis of a relation of the symbols 180 rearranged.

The second display control unit 115 displays the first area 191 and the second area 192 in the second display area 101A. When a predetermined condition is fulfilled, whenever the symbols 180 are rearranged, it reads out the position data of the first symbol 181 and the position data of the second symbol 182 from the display symbol memory 107 and alternately executes an operation of replacing an area, which is not a first area 191, with the first area 191, as an area corresponding to a position of the first symbol 181, in the second display area 101A and an operation of replacing an area, which is not a second area 192, with the second area 192, as an area corresponding to a position of the second symbol 182, in the second display area 101A. In other words, the controller 100 executes the third process of alternately executing an operation of replacing an area, which is not a first area 191, with the first area 191, as an area corresponding to a position of the first symbol 181 rearranged, in the second display area 101A and an operation of replacing an area, which is not a second area 192, with the second area 192, as an area corresponding to a position of the second symbol 182 rearranged, in the second display area 101A, whenever the symbols 180 are rearranged.

In addition, when a predetermined condition is fulfilled, whenever the symbols 180 are rearranged, the second display control unit 115 reads out the position data of the first symbol 181 from the display symbol memory 107, and replaces and displays an area, which is not the first area 191, with the first area 191, as an area corresponding to a position of the first symbol 181, in the second display area 101A, reads out the position data of the second symbol 182 received from the other slot machines via the communication device 103 and replaces and displays an area, which is not the second area 192, with the second area 192, as an area corresponding to a position of the second symbol 182, in the second display area 101A.

Whenever the symbols 180 are rearranged, a rearrangement position data preparing unit 116 prepares the first symbol position data relating to a position of the symbols 180 rearranged and transmits the prepared first symbol position data to the other slot machines through the communication device 103. In other words, the controller 100 executes a fourth process of, when a predetermined condition is fulfilled, replacing an area, which is not the first area 191, with the first area 191, as an area corresponding to a position of the first symbol 181 rearranged, transmitting a first symbol position data relating to a position of the first symbol 181 rearranged to the other slot machine, receiving from the other slot machine a second symbol position data relating to a position of the second symbol 182 rearranged in the other slot machine and replacing an area, which is not the second area 192, with the second area 192, as an area corresponding to a position based on the second symbol position data, whenever the symbols 180 are rearranged.

In addition, the combination payout determining unit 111 determines an award of a payout relating to a relation between the first area 191 and the second area 192 displayed in the second display area 101A at a specific timing. The payout award unit 113 awards a payout based on the determination of the combination payout determining unit 111. In other words, the controller 100 executes a fifth process of awarding a payout relating to a relation between the first area 191 and the second area 192 displayed in the second display area 101A at a specific timing.

In the mean time, each block of the controller 100 may be structured with a hardware or software, as required.

(Operation of the Controller 100)

In the followings, an operation of the controller 100 will be described. First, the symbols to be rearranged are determined by the rearrangement symbol determining unit 106 and the determined symbols to be rearranged are stored in the rearrangement symbol memory 105. The symbols to be rearranged, which the rearrangement symbol memory 105 stores, are stored in the display symbol memory 107. The symbols to be rearranged, which are stored in the display symbol memory 107, are enabled to be displayed in the first display area 101B by the first display control unit 114. When a unit game is executed by the game executing unit 110, a variable display of the symbols is started and the symbols to be rearranged, which are stored in the display symbol memory 107, are displayed in the first display area 101B in a timing at which a predetermined time has elapsed from the start of the variable display, so that the symbols 180 are rearranged. Thereby, the controller 100 executes a first process of rearranging the symbols 180 based on a predetermined timing.

Then, a winning is determined by a relation of the symbols 180 rearranged and a payout based on the winning is awarded by the combination payout determining unit 111 and the payout award unit 113. Thereby, the controller 100 executes a second process of determining a winning on the basis of a relation of the symbols 180 rearranged.

Furthermore, in a bonus game, whenever the symbols 180 are rearranged, an operation of replacing an area, which is not a first area 191, with the first area 191, as an area corresponding to a position of the first symbol 181 rearranged and an operation of replacing an area, which is not a second area 192, with the second area 192, as an area corresponding to a position of the second symbol 182 rearranged are alternately executed. To be more specific, as shown in FIG. 1, whenever the symbols 180 are rearranged in the central liquid crystal panel 5B (first display area 101B, second display area 101A), areas 155b, 255b, which are not the first area 191, are replaced with the first area 191, as an area corresponding to a position 155b of “SUN” that is the first symbol 181 rearranged. In addition, areas 154a, 254a, 152c, 252c, which are not the second area 192, are replaced with the second area 192, as an area corresponding to a position of “THUNDER” that is the second symbol 182 rearranged. Thereby, the controller 100 executes a third process of, based on a predetermined timing, alternately executing an operation of replacing an area, which is not a first area 191, with the first area 191, as an area corresponding to a position of a first symbol 181 rearranged, and an operation of replacing an area, which is not a second area 192, with the second area 192, as an area corresponding to a position of a second symbol 182 rearranged, whenever the symbols 180 are rearranged.

Further, in a bonus game, whenever the symbols 180 are rearranged, the first symbol position data relating to a position of the first symbol 181 rearranged and the second symbol position data relating to a position of the second symbol 182 rearranged are transmitted/received to/from the other slot machines through the communication device 103. An area, which is not a first area 191, is replaced with the first area 191, as an area corresponding to a position of the first symbol 181 rearranged and an area, which is not a second area 192, with the second area 192, as an area corresponding to a position based on a position of the second symbol 182 rearranged in the other slot machine. Thereby, the controller 100 executes a fourth process of, based on a predetermined timing, replacing an area, which is not the first area 191, with the first area 191, as an area corresponding to a position of the first symbol 181 rearranged, transmitting a first symbol position data relating to a position of the first symbol 181 rearranged to the other slot machine, receiving from the other slot machine a second symbol position data relating to a position of the second symbol 182 rearranged in the other slot machine and replacing an area, which is not the second area 192, with the second area 192, as an area corresponding to a position based on the second symbol position data, whenever the symbols 180 are rearranged.

Moreover, in a case where a winning is determined by a relation of the symbols 180 rearranged and a payout based on the winning is awarded in a bonus game, a payout relating to a relation between the first area 191 and the second area 192 displayed in the second display area 101A is further awarded. In addition, at a time at which a bonus game is ended, a payout relating to a relation between the first area 191 and the second area 192 displayed in the second display area 101A is awarded. Thereby, the controller 100 executes a fifth process of awarding a payout relating to a relation between the first area 191 and the second area 192 displayed in the second display area 101A, at a specific timing.

As clearly seen from the above operations, the slot machine 1 realizes a playing method comprising the steps of: rearranging symbols 180 based on a predetermined timing; determining a winning by a relation of the symbols 180 rearranged; when a predetermined condition is fulfilled, alternately executing an operation of replacing an area, which is not a first area 191, with the first area 191, as an area corresponding to a position of a first symbol 181 rearranged, and an operation of replacing an area, which is not a second area 192, with the second area 192, as an area corresponding to a position of a second symbol 182 rearranged, whenever the symbols 180 are rearranged; when a predetermined condition is fulfilled, replacing an area, which is not the first area 191, with the first area 191, as an area corresponding to a position of the first symbol 181 rearranged, transmitting a first symbol position data relating to a position of the first symbol 181 rearranged to the other slot machine, receiving from the other slot machine a second symbol position data relating to a position of the second symbol 182 rearranged in the other slot machine and replacing an area, which is not the second area 192, with the second area 192, as an area corresponding to a position based on the second symbol position data, whenever the symbols 180 are rearranged; and awarding a payout relating to a relation between the first area 191 and second area 192 displayed, at a specific timing.

According to the above playing method, based on a predetermined timing, whenever the symbols are rearranged in the first area, an operation of replacing an area, which is not a first area, with the first area, as an area corresponding to a position of a first symbol rearranged and an operation of replacing an area, which is not a second area, with the second area, as an area corresponding to a position of a second symbol rearranged, are alternately executed. When a predetermined condition is fulfilled, whenever the symbols are rearranged in the first display area, an area, which is not the first area, is replaced with the first area, as an area corresponding to a position of the first symbol rearranged in the second display area, a first symbol position data relating to a position of the first symbol rearranged is transmitted to the other slot machine, a second symbol position data relating to a position of the second symbol rearranged in the other slot machine is received from the other slot machine and an area, which is not the second area, is replaced with the second area, as an area corresponding to a position based on the second symbol position data. Then, at a specific timing, a payout relating to a relation between the first area and the second area displayed is awarded. Thereby, it is visually recognized whether a payout is awarded or not by seeing the first area and second area displayed in the second area, so that a new entertainment characteristic can be provided.

(Display State)

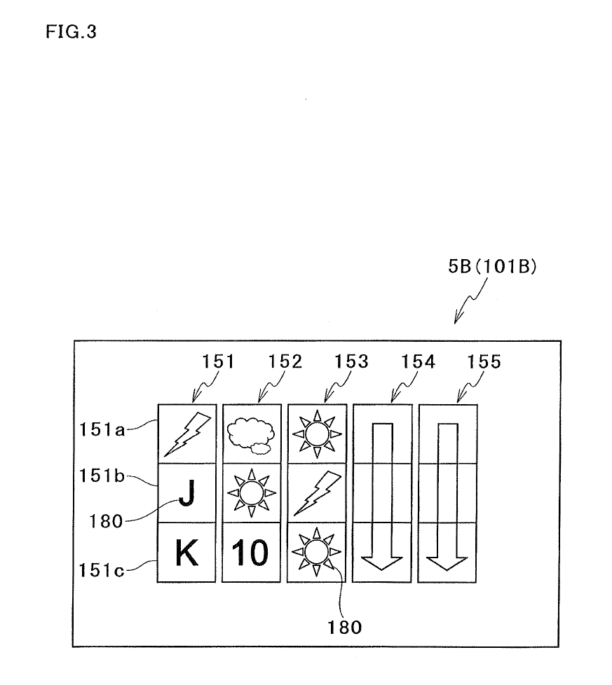

It is specifically described an example of a display state of the first display area 101B and the second display area 101A, with respect to the operation processes of the slot machine 1 and the playing method. In the mean time, as shown in FIG. 3, the display state is described with reference to a structure in which the first display area 101B arranges the symbols in a video reel manner.

The first display area 101B has display windows 151˜155 as an area that arranges the symbols 180. The display windows 151˜155 are arranged in a center of the first display area 101B. A symbol column consisting of the symbols 180 is scrolled in the display windows 151˜155 (see FIG. 3). In addition, the respective display windows 151˜155 are divided into upper stages 151a, 152a, 153a, 154a, 155a, center stages 151b, 152b, 153b, 154b, 155b and lower stages 151c, 152c, 153c, 154c, 155c. The symbols 180 are respectively stopped (arranged) in the respective stages 151a˜155a, 151b˜155b, 151c˜155c. For example, in FIG. 3, “THUNDER” is stopped in the upper stage 151a of the display window 151, “SUN” is stopped in the center stage 152b of the display window 152 and “SUN” is stopped in the lower stage 153c of the display window 153. Thereby, the display windows 151˜155 display a symbol matrix consisting of 5 columns/3 rows. In the mean time, the symbol matrix is not limited to 5 columns/3 rows.

In addition, when the predetermined number of symbols referred to as a scatter symbol is displayed as a winning combination in the first display area 101B, a process of awarding a payout such as coin is performed. To be more specific, as shown in FIG. 3, when four or more “THUNDER” of scatter symbol are rearranged (displayed) in the first display area 101B, a coin is paid out.

In the mean time, in this embodiment, “THUNDER” is provided as a scatter symbol. However, the scatter symbol is not limited thereto. For example, another symbol may be provided as a scatter symbol. In addition, a scatter symbol may be selected by a player. Additionally, a payline L may be provided to horizontally traverse the center stages of each of the display windows 151˜155. When the symbols stopped on the payline L constitute a predetermined combination, a process of paying out a coin and the like may be executed. In other words, the payline L is provided to determine a combination of the symbols 180. When the symbols 180 are arranged on and out of the payline L, a combination is determined only for the symbols 180 rearranged on the payline L. As a determination of the combination, when a winning combination is made, a process of paying out a coin based on the winning combination is carried out, for example.

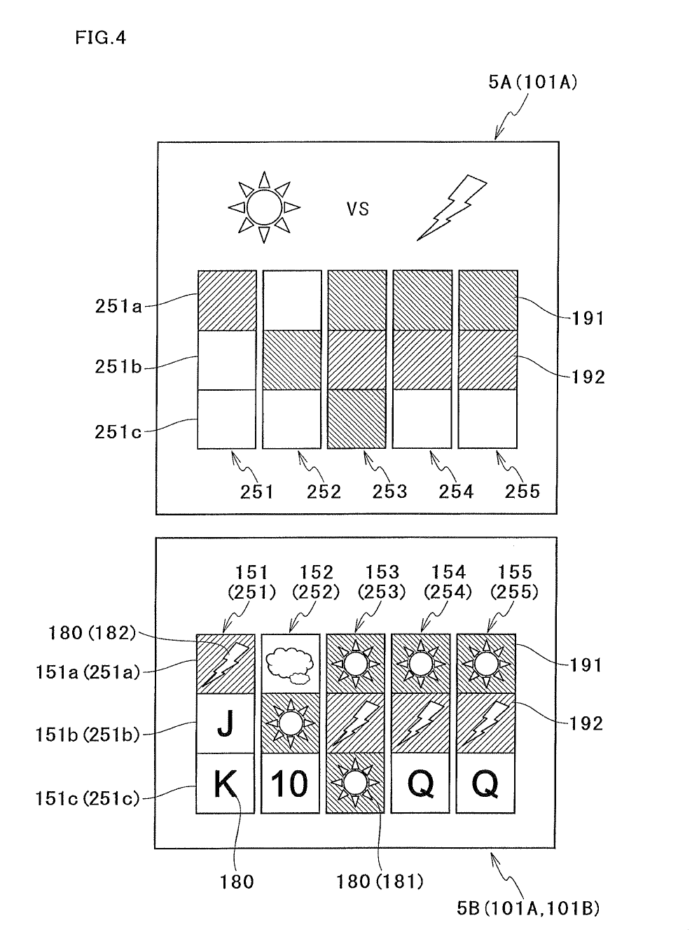

As shown in FIG. 4, the second display area 101A has a plurality of areas 251˜255 including a first area 191 (red area, depicted as oblique lines from upper left to lower right) corresponding to “SUN” that is the first symbol 181, and a second area 192 (blue area, depicted as oblique lines from upper right to lower left) corresponding to “THUNDER” that is the second symbol 182. The areas 251˜255 are arranged in the center of the second display area 101A. The first area 191, the second area 192 and the other areas are displayed in the areas 251˜255. FIG. 4 shows a state in which the symbols 180 are rearranged. For example, the second symbol 182 “THUNDER”, the symbol 180 “J” and the symbol 180 “K” are rearranged in the display windows 151a, 151b, 151c of the first display area 101B. Correspondingly, in the second display area 101A, the area 251a is shown as a blue area that is the second area 192 and the area 251b and the area 251b are shown as the other areas. Likewise, in the display windows 152a, 152b of the first display area 101B, the symbol 180 “CLOUD”, the first symbol 181 “SUN” and the symbol 180 “10” are rearranged. Correspondingly, in the second display area 101A, the areas 252a, 252c are shown as the other areas and the area 252b is shown as a red area that is the first area 191. In other words, as shown in FIG. 4, the first symbol 181 and the second symbol 182 and the first area 191 and the second area 192 that correspond to the first symbol 181 and the second symbol 182 may be displayed in a same area, or alternatively may be displayed in different areas. When the first symbol 181 and the second symbol 182 and the first area 191 and the second area 192 are displayed in a same area, a corresponding relation of the first symbol 181 and the first area 191 and a corresponding relation of the second symbol 182 and the second area 192 can be clarified for a player. In the mean time, when the first symbol 181 and the second symbol 182 and the first area 191 and the second area 192 are displayed in the different areas, it makes it possible for a player to easily recognize the first area 191 and the second area 192.

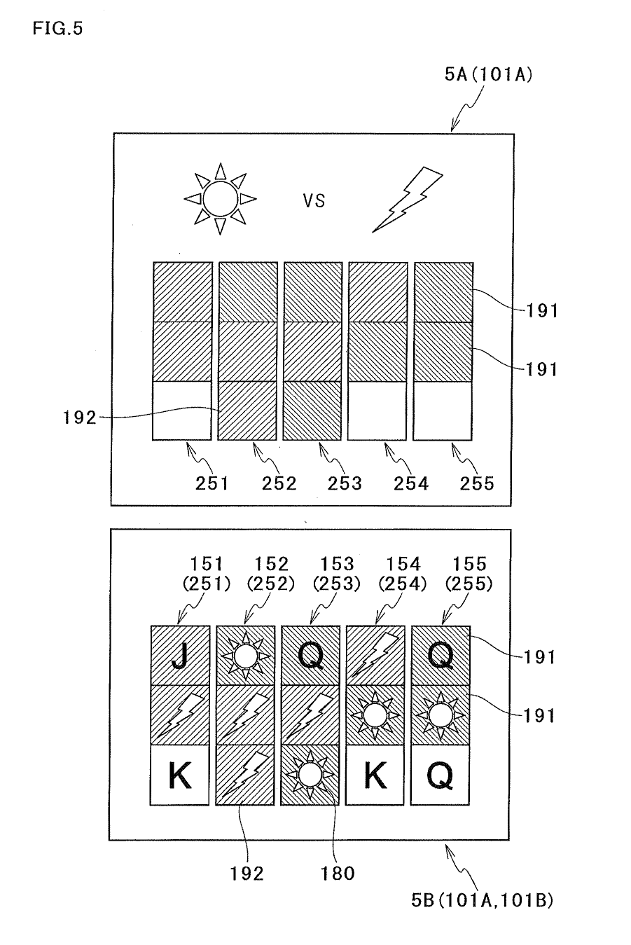

FIG. 5 shows a state in which the symbols are further rearranged after the symbols 180 are rearranged in FIG. 4. As shown in FIG. 5, the second symbol 182 “THUNDER” is rearranged in the display window 151b and the area 251b is correspondingly replaced with the second area 192 from the other areas. The first symbol 181 is rearranged in the display window 152a and the area 252a is correspondingly replaced with the first area 191 from the other areas. The second symbol 182 is rearranged in the display window 152b and the area 252b is correspondingly replaced with the second area 192 from the other areas. The second symbol 182 is rearranged in the display window 152c and the area 252c is correspondingly replaced with the second area 192 from the other areas. The first symbol 181 is rearranged in the display window 154b and the area 254b is correspondingly replaced with the first area 191 from the second area 192. Like this, an area, which is not the first area 191, is replaced with the first area 191, as an area corresponding to a position of the first symbol 181 rearranged, and an area, which is not the second area 192, is replaced with the second area 192, as an area corresponding to a position of the second symbol 182 rearranged.

(Symbol, Combination and the Like)

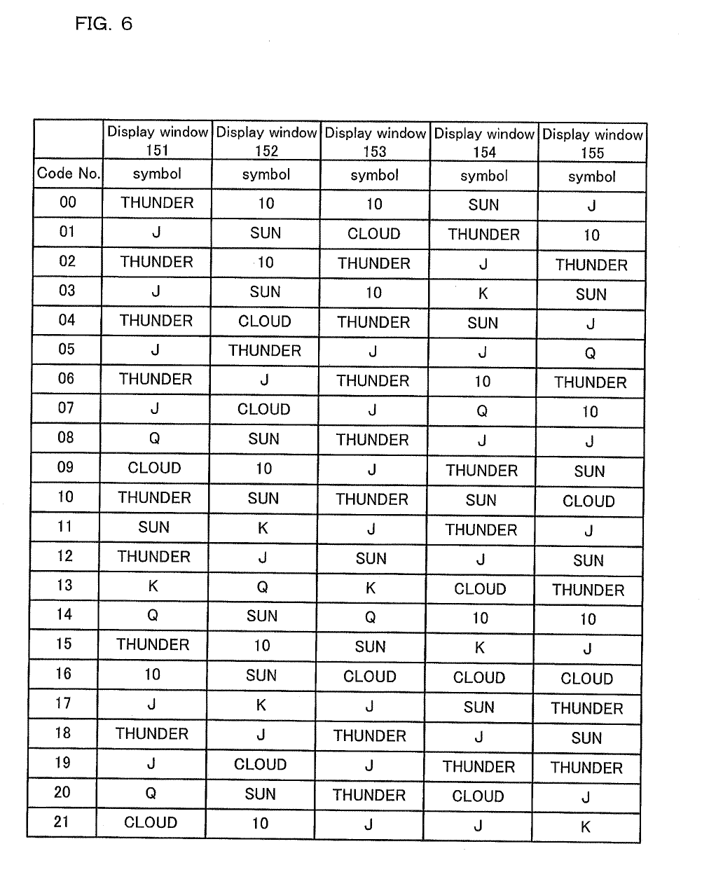

As shown in FIG. 6, the symbols 180 to be displayed in the display windows 151˜155 of the first display area 101B constitute the symbol columns by 22 symbols. The symbols constituting the respective symbol columns are given with one code number of 0˜21. Each of the symbol columns is constituted with a combination of symbols of “THUNDER,” “J,” “Q,” “CLOUD, ” “SUN, ” “K” and “10.”

The three successive symbols in the symbol columns are displayed (arranged) in the upper stages 151a, 152a, 153a, 154a, 155a, the center stages 151b, 152b, 153b, 154b, 155b and the lower stages 151c, 152c, 153c, 154c, 155c, respectively, so that they constitute a symbol matrix of 5 columns/3 rows in the display windows 151˜155. When a BET button is pushed and then a start button is pushed to start a game, the symbol columns constituting the symbol matrix are scrolled. When a predetermined time period has elapsed after the scroll, each scroll of the symbols is stopped (rearranged).

In addition, for each symbol, a predetermined scatter symbol is determined in advance. The scatter symbol is a symbol that allows an advantageous state to a player when the predetermined number of scatter symbols is displayed in the display windows 151˜155. The advantageous state is a state in which a coin is paid out in accordance with the scatter symbol, a state in which the payout-number of coins is added to the game media, a state in which a bonus game is started, and the like.

To be more specific, when three or more symbols of “SUN” are rearranged in the display window 151˜155, a bonus is triggered and a gaming state is shifted to a bonus game from a base game. In addition, when four or more symbols of “THUNDER” are displayed in the display windows 151˜155, 20 coins (game medium) are paid out per one bet.

In the mean time, the bonus game is a gaming state that is more advantageous than a base game. In one embodiment, the bonus game is a free game. The free game is a gaming state allowing a player to play a game for a predetermined number of times, without betting a coin. The bonus game is not particularly limited as long as it is a gaming state advantageous to the player, i.e., it is more advantageous than the base game. For example, the bonus game may include a state in which it is possible to obtain more game media than the base game, a state in which it is possible to obtain a game medium in a higher probability than in the base game, a state in which a game medium is less consumed than in the base game, and the like. Specifically, a free game, a second game, a feature game and the like are examples of the bonus game.

(Network Structure of Slot Machine 1)

In the followings, in the slot machine 1 structured as described above, an example of a network structure with the other slot machines will be described.

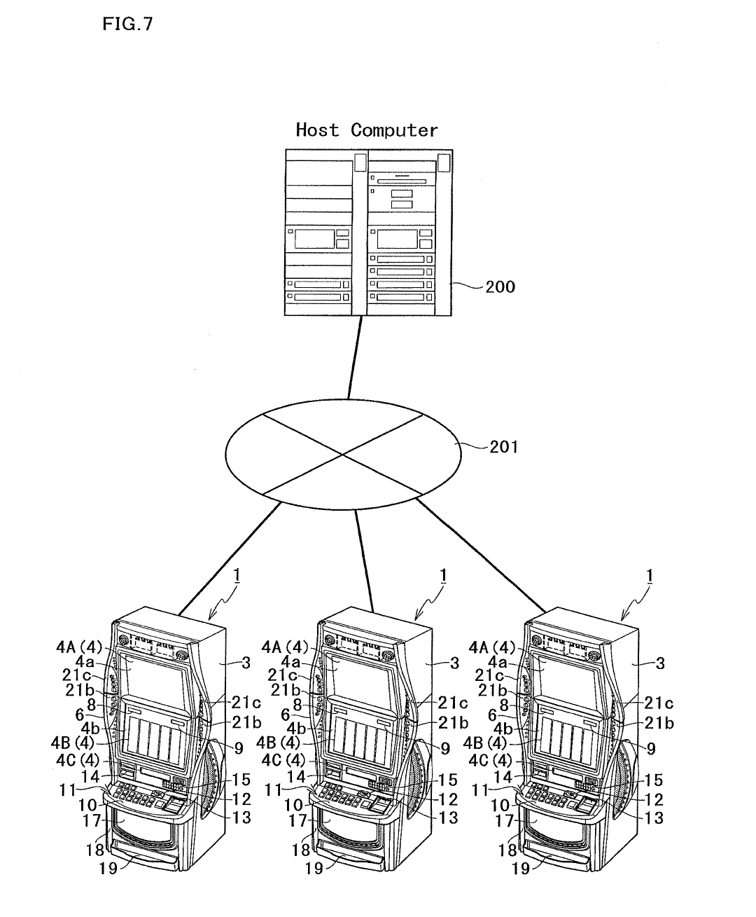

As shown in FIG. 7, the slot machine 1 is associated with a network 201. The slot machine 1 is in data-communication with the other slot machines through the network 201. In addition, a host computer 200 is associated with the network 201. The host computer 200 performs a data communication with the slot machines 1. As described below, the host computer 200 stores the jackpot to be received from the respective slot machines, searches a competition party with the other slot machine in a bonus game of the slot machine, determines the number of bonus game and gives the jackpot. Meanwhile, in this embodiment, the host computer 200 is provided. However, a structure that does not comprise a host computer 200 may be possible. In addition, although the network 201 is wired, a wireless network may be also possible.

(Mechanical Structure of the Slot Machine 1)

In the followings, it will be described an example of the slot machine 1 structured in a mechanical and electrical manner.

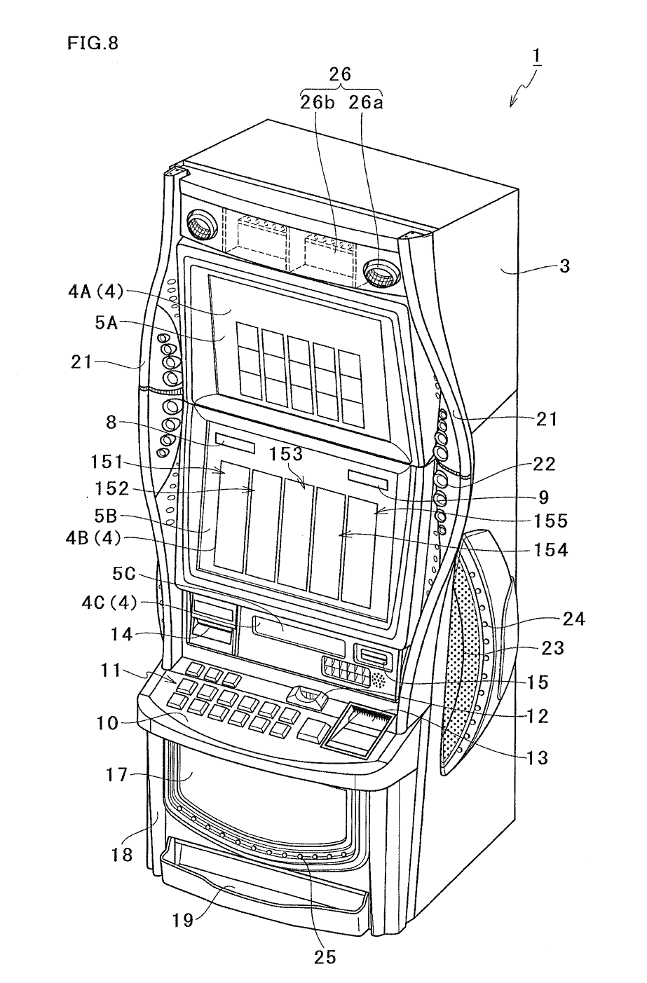

As shown in FIG. 8, the slot machine 1 is an upright-type slot machine provided in a game arcade such as casino and the like and has a cabinet 3 for receiving electrical or mechanical parts so as to execute a game aspect. As a display unit 4 for displaying the game information based on a game operation of a player, there are provided an upper variable display unit 4A, a central variable display unit 4B and a lower variable display unit 4C, for example. Each of the display units 4A, 4B, 4C is attached to a front of the cabinet 3 that is longitudinally long.

The upper variable display unit 4A is a display unit on which a player fixes the eyes during the unit game and has a transparent upper liquid crystal panel 5A that is fixed to a front door of the cabinet 3. A variety of effect images are displayed in the upper liquid crystal panel 5A during the unit game. For example, an effect of a moving picture is performed in the upper liquid crystal panel 5A when a winning is made, for example.

The central variable display unit 4B is a rotating symbol display panel on which a player always fixes the eyes and has a transparent central liquid crystal panel 5B that is fixed to the front door of the cabinet 3. To the central liquid crystal panel 5B are provided five display windows 151˜155. Moreover, a payout-number display unit 8 and a credit-number display unit 9 are displayed in an upper part of the central liquid crystal panel 5B.

The lower variable display unit 4C has a lower liquid crystal panel 5C that displays a point-number recorded in a card or a point-number of a game. A numerical value displayed in the lower liquid crystal panel 5C is based on a display result of the central variable display unit 4B. When a winning combination is made in the central variable display unit 4B, a point-number of a game displayed in the lower liquid crystal panel 5C is added on the basis of the winning combination made. A ticket printer 14 is provided to a left side of the lower liquid crystal panel 5C and a card reader 15 is provided to a right side of the lower liquid crystal panel 5C.

An operating table 10 that protrudes forward from the front face of the cabinet 3 is disposed below the lower variable display unit 4C. On the operating table 10, there are arranged operating buttons 11 (for example, bet button, collect button, start button 11a and the like) as an operating unit enabling a player to operate a game. In addition, a coin insertion slot 12 and a bill insertion slot 13 are provided to the operating table.

A waist-position panel 17 is disposed below the operating table 10. The waist-position panel 17 is a plastic panel having a game-related image printed thereto. The waist-position panel 17 is fixed to a lower front door 18 and illuminated by a cold cathode-ray tube. In addition, a coin receiving portion 19 that collects coins, which are paid out on the basis of a game result, is disposed below the waist-position panel 17.

Furthermore, a light-emitting unit 20 is disposed to the cabinet 3 of the slot machine 1 so that it surrounds a game area including the upper variable display unit 4A, the central variable display unit 4B, the lower variable display unit 4C and the operating table 10. The light-emitting unit 20 comprises side lamps 22 that are provided to inclined parts 21, which are protruded in a bow shape at front right and left ends of the cabinet 3 and at side parts over the upper variable display unit 4A, the central variable display unit 4B and the lower variable display unit 4C, speaker lamps 24 that are provided to arc-shaped speaker 23, which are sideways protruded at the right and left ends of the cabinet 3 adjacent to the operating table 10, and are arranged along edges of the speakers 23, under lamps 25 that are provided to a lower front door 18 and arranged along lower edges of the waist-position panel 17, and top lamps 26 that are provided to an upper part of the upper variable display unit 4A and have power lamps 26a disposed at both sides and central band-shaped lamps 26b arranged in a horizontal direction.

(Electrical Structure of the Slot Machine 1)

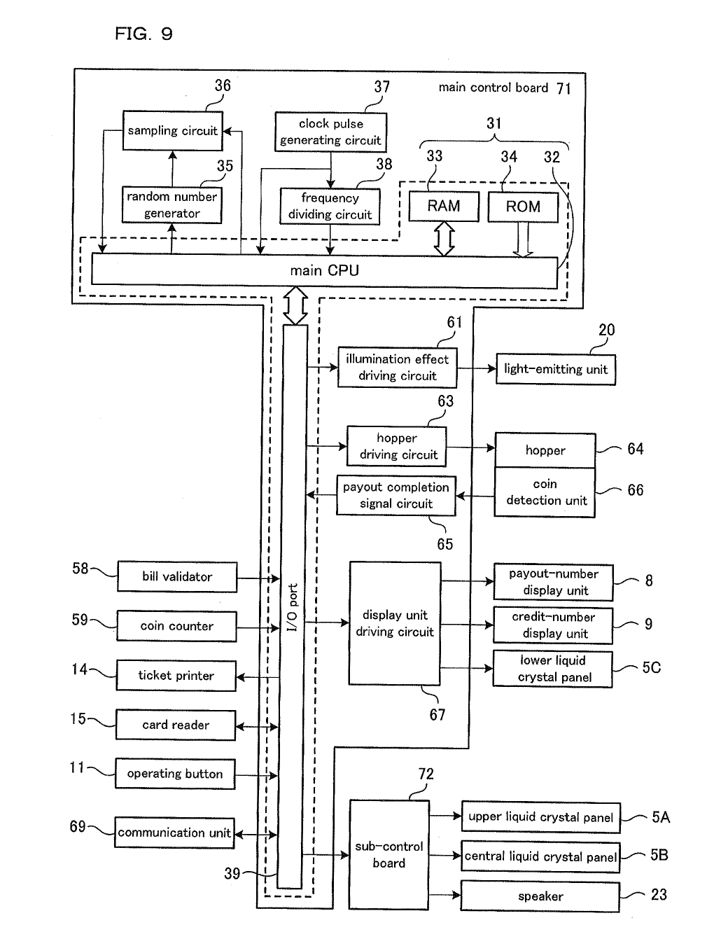

FIG. 9 is a block diagram showing an entire electrical structure of the slot machine 1. As shown in FIG. 9, the slot machine 1 has many components about a main control board 71 including a microcomputer 31. The main control board 71 has a microcomputer 31, a random number generator 35, a sampling circuit 36, a clock pulse generating circuit 37, a frequency dividing circuit 38, an illumination effect driving circuit 61, a hopper driving circuit 63, a payout completion signal circuit 65 and a display unit driving circuit 67.

The microcomputer 31 has a main CPU 32, a RAM 33 and a ROM 34. The main CPU 32 operates in accordance with a program stored in the ROM 34 and executes an input/output of a signal to and from the other components through an I/O port 39, thereby controlling an overall operation of the slot machine 1. The RAM 33 stores data or a stop symbol determining program used when the main CPU 32 operates. For example, a random number value that is sampled by the sampling circuit 36 is temporarily maintained in the RAM after a game starts. In addition, the code numbers of the reels R1, R2, R3 are stored in the RAM. The ROM 34 stores a program that is executed by the main CPU 32 and permanent data.

The random number generator 35 is operated in accordance with an instruction of the main CPU 32 and generates a random number within a predetermined range. The sampling circuit 36 samples any random number of the random numbers that are generated by the random number generator 35 in accordance with an instruction of the main CPU 32 and inputs the sampled random number into the main CPU 32. The clock pulse generating circuit 37 generates a reference clock for operating the main CPU 32 and the frequency dividing circuit 38 inputs a signal that the reference clock is divided in a predetermined period to the main CPU 32.

Moreover, the main control board 71 is associated with the operating buttons 11 including a start button for inputting an instruction to stop the scroll of the symbol columns, a collect button, a bet button and the like and allows signals corresponding to the push of the buttons to be inputted into the main CPU 32 via the I/O port 39.

In addition, the main control board 71 is associated with a bill validator 58, a coin counter 59, a ticket printer 14, a card reader 15 and a communication unit 69.

The bill validator 58 reads an image of bill inserted into the bill insertion slot 13 and receives the normal bill in the cabinet 3. In addition, when receiving the normal bill, the bill validator 58 outputs an input signal to the main CPU 32 based on an amount of the bill. The main CPU 32 stores a credit-number in the RAM 33, which corresponds to the amount of bill transmitted by the input signal.

The coin counter 59 is provided in the coin insertion slot 12 and identifies whether the coin inserted into the coin insertion slot 12 by the player is normal or not. The abnormal coin is discharged to the coin receiving portion 19. In addition, the coin counter 59 outputs an input signal to the main CPU 32 when it detects a normal coin.

The ticket printer 14 prints a barcode on a ticket, in which data such as credit-number stored in the RAM 33, the day and time and identification number of the slot machine 1 is coded, based on the control signal outputted from the main CPU 32, and then outputs a ticket having the barcode attached thereto.

The card reader 15 reads the data from a smart card to transmit it to the main CPU 32, or writes the data to the smart card based on a control signal from the main CPU 32.

The communication unit 69 is provided to communicate with a host computer 200 equipped in the game arcade, through the network 201 (communication line 201).

The illumination effect driving circuit 61 outputs an effect signal that causes the light-emitting unit 20 to execute an illumination effect. The light-emitting unit 20 consists of many lamps or LED including the side lamps 22, the speaker lamps 24, the under lamps 25 and the top lamps 26.

The hopper driving circuit 63 drives a hopper 64 under control of the main CPU 32. The hopper 64 executes an operation of paying out a coin and pays out the coin to the coin receiving portion 19. The payout completion signal circuit 65 inputs data of the coin-number from a coin detection unit 66 associated thereto and inputs a signal, which notifies payout completion of the coin when the coin-number reaches a predetermined number, to the main CPU 32. The coin detection unit 66 measures the number of coins paid out by the hopper 64 and inputs data of the measured number to the payout completion signal circuit 65. The display unit driving circuit 67 controls display operations of various display units such as the lower liquid crystal panel 5C.

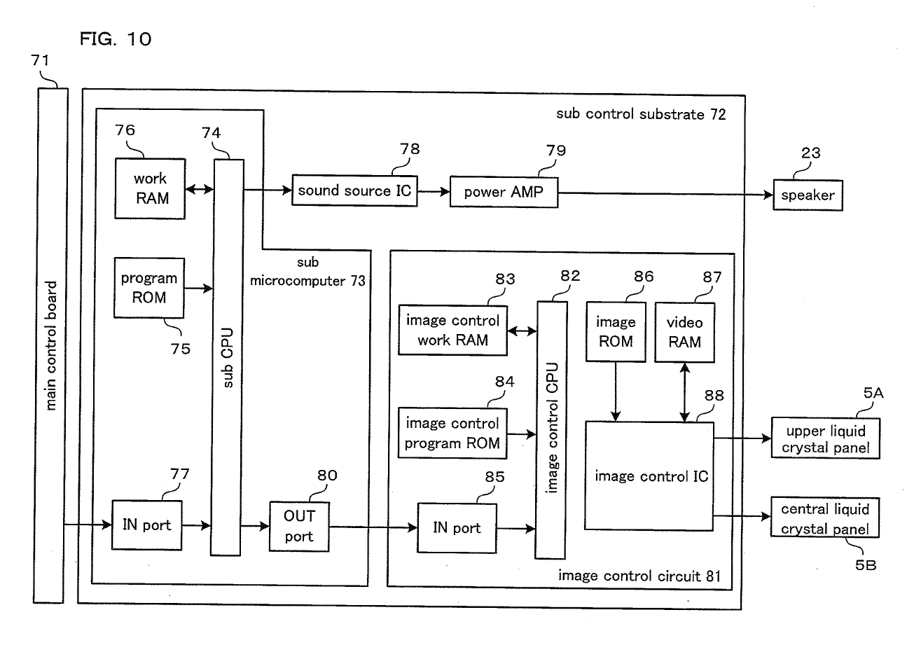

Further, the main control board 71 is associated with a sub control board 72. As shown in FIG. 10, the sub control board 72 performs a display control of the upper liquid crystal panel 5A of the upper variable display unit 4A, a display control of the central liquid crystal panel 5B of the central variable display unit 4B and an output control of a voice sound by the speaker, based on commands inputted from the main control board 71. The sub control board 72 is comprised on a circuit board different from the circuit board constituting the main control board 71 and has a microcomputer 73 (hereinafter, referred to as “sub microcomputer”) as a main component. In addition, the sub control board has a sound source IC 78 controlling a voice sound outputted from the speaker 23, a power AMP 79 serving as an amplifier and an image control circuit 81 serving as a display control means of the upper liquid crystal panel 5A and the central liquid crystal panel 5B.

The sub microcomputer 73 has a sub CPU 74 that performs a control operation in accordance with a control command transmitted from the main control board 71, a program ROM 75 serving as a memory means, a work RAM 76, an IN port 77 and an OUT port 80. Although the sub control board 72 does not have a clock pulse generating circuit, a frequency dividing circuit, a random number generator and a sampling circuit, it is structured to execute a random number sampling on the operating program of the sub CPU 74. The program ROM 75 stores a control program that is executed in the sub CPU 74. The work RAM 76 is structured to serve as a temporary memory means when the control program is executed in the sub CPU 74.

The image control circuit 81 has an image control CPU 82, an image control work RAM 83, an image control program ROM 84, an IN port 85, an image ROM 86, a video RAM 87 and an image control IC 88. The image control CPU 82 determines an image that is displayed in the upper liquid crystal panel 5A and the central liquid crystal panel 5B, in accordance with the image control program stored in the image control program ROM 84, based on a parameter that is set in the sub microcomputer 73.

The image control program ROM 84 stores an image control program that is related to a display in the upper liquid crystal panel 5A and the central liquid crystal panel 5B, or various selection tables. The image control work RAM 83 is configured to serve as a temporary memory means when the image control program is executed in the image control CPU 82. The image control IC 88 forms an image corresponding to the content determined in the image control CPU 82 and outputs it to the upper liquid crystal panel 5A and the central liquid crystal panel 5B.

The image ROM 86 stores dot data for forming an image. The video RAM 87 serves as a temporary memory means when an image is formed in the image control IC 88.

(Electrical Structure of Host Computer 200)

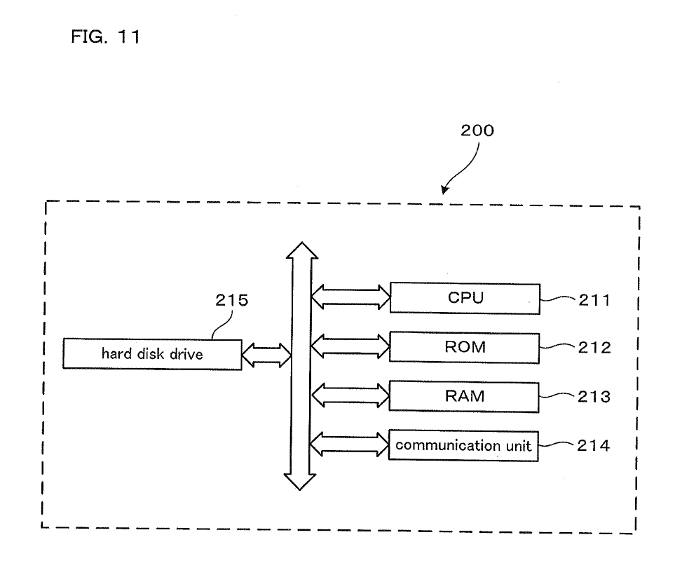

FIG. 11 is a block diagram showing an electrical structure of the entire host computer 200. As shown in FIG. 11, the host computer 200 comprises a microcomputer having a CPU 211, a ROM 212 and a RAM 213, a hard disk drive 215 that is another constitutional element, i.e., memory device, and a communication unit 214.

The CPU 211 is operated in accordance with a program stored in the ROM 212, performs an input/output of a signal with the other constitutional elements through an I/O port and controls an entire operation of the host computer 200. The RAM 213 stores a program or data that is used when the CPU 211 operates, for example a jackpot. The communication unit 214 is provided to perform a communication with the slot machines 1 equipped in a game arcade. The hard disk drive 215 permanently stores a variety of data such as operating status of a game arcade and the like. Meantime, a server processing that is executed by the CPU 211 will be described later.

(Operation of the Slot Machine 1: Main Control Board 71)

In the followings, a process that is performed in the slot machine 1 will be described. As the main CPU 32 reads out and executes a game program, a game is progressed.

(Game Executing Process)

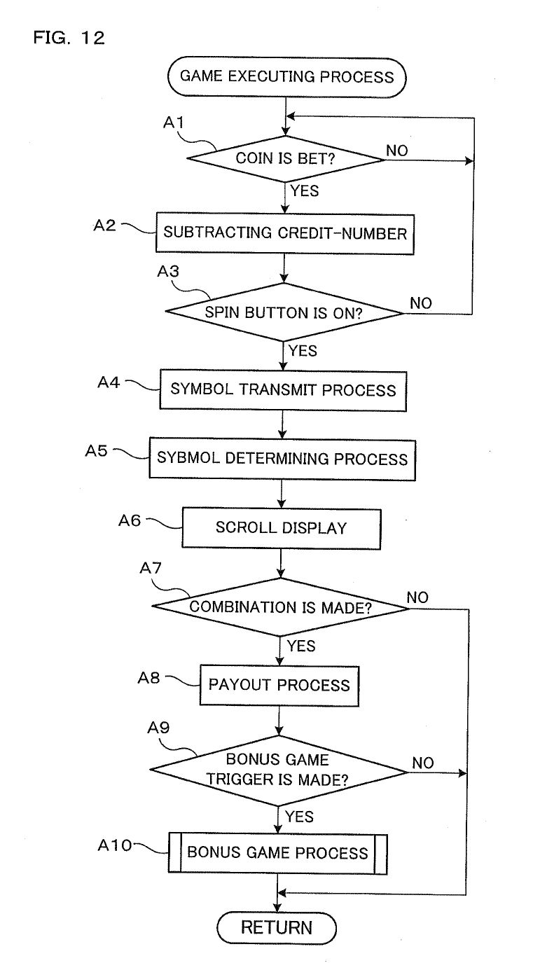

The main CPU 32 of the slot machine 1 carries out a game executing process routine shown in FIG. 12. When the game executing process routine is carried out, the main CPU 32 determines whether a coin is bet or not (A1). In this process, it is determined whether an input signal due to a push of the bet button is received or not. When it is determined that a coin is not bet (A1, N0), the step of A1 is re-executed, so that the CPU waits until a coin is bet.

In the mean time, when it is determined that a coin is bet (A1, YES), the credit-number stored in the RAM 33 is subtracted in accordance with the coin-number (A2). Meanwhile, when the number of coins bet is greater than the credit-number stored in the RAM 33, the step of A2 is re-executed without subtracting the credit-number. In addition, when the number of coins bet exceeds the upper limit (in this embodiment, 50 pieces) allowing a player to bet a coin in a single game, a step of A3 is executed without subtracting the credit-number.

Next, it is determined whether a start button is ON or not (A3). When it is determined that the start button is not ON (A3, NO), the process is returned to the step of S10. Meanwhile, when it is determined that the start button is not ON (for example, the start button is not ON and an instruction to end the game is inputted), it is canceled the subtraction result in the step of A2.

In the mean time, when it is determined that the start button is ON (A3, YES), a jackpot transmit process is executed (A4). In other words, a game value corresponding to a predetermined percentage of the coins bet is transmitted as a jackpot to the host computer 200.

Next, a symbol determining process is executed (A5). In other words, a stop symbol determining program stored in the RAM 33 is executed, so that it is determined a symbol matrix including the symbols 180 to be stopped.

Then, the symbols 180 of the display windows 151˜155 are scrolled (A6). After the scroll of the symbols 180 is started and then a predetermined time (base time) has elapsed, the symbol matrix determined in the step of A5 is stopped (rearranged) in the display windows 151˜155.

Then, it is determined whether a combination is made or not, i.e., whether a combination of the symbols 180 stopped in the display windows 151˜155 is a winning combination or not (A7). When it is determined that the combination is not a winning combination (A7, NO), this routine is ended. In the mean time, when it is determined that the combination is a winning combination (A7, YES), a payout process is executed (A8). In other words, a payout-number of coins based on the winning combination made is calculated. When the coins to be paid out are stored, a predetermined number of credits is added to the credit-number stored in the RAM 33. In the mean time, when the coins are paid out, a control signal is transmitted to the hopper 64, so that a predetermined number of coins is paid out through the coin receiving portion 19.

Then, it is determined whether a bonus trigger is made as a winning combination (A9). In other words, it is determined whether a combination of “SUN” is arranged on the payline L. When it is determined that a bonus trigger is not made (A9, NO), this routine is ended. In the mean time, when it is determined that a bonus trigger is made (A9, YES), a bonus game process is executed (A10). The bonus game process will be described later. Then, this routine is ended.

(Bonus Game Process)

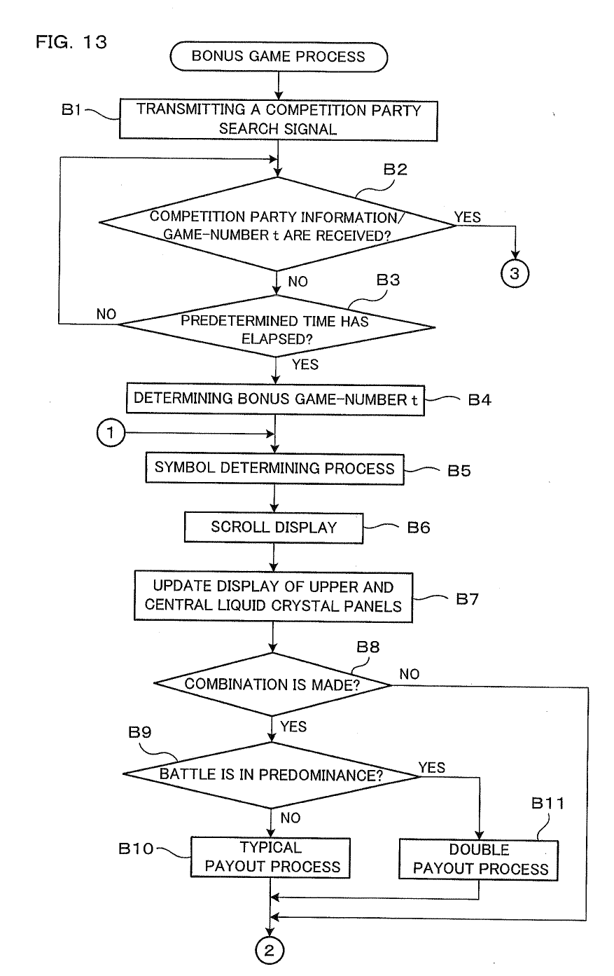

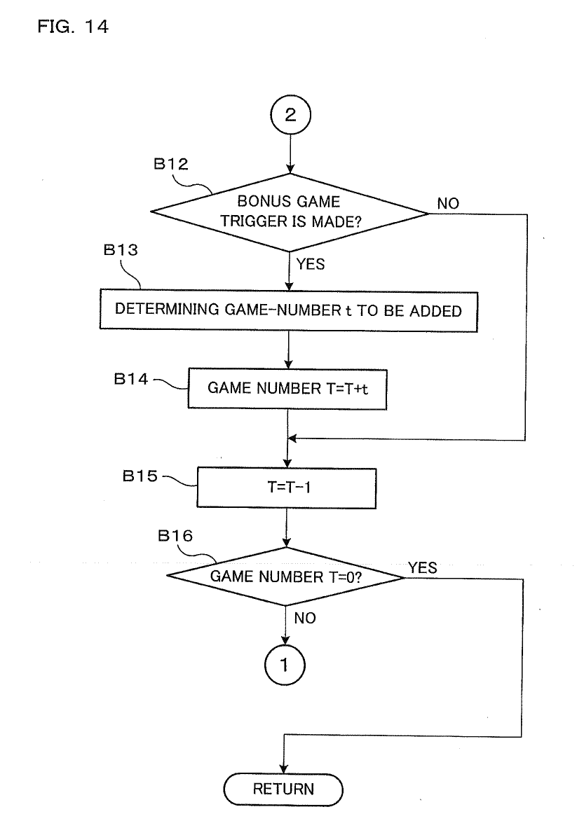

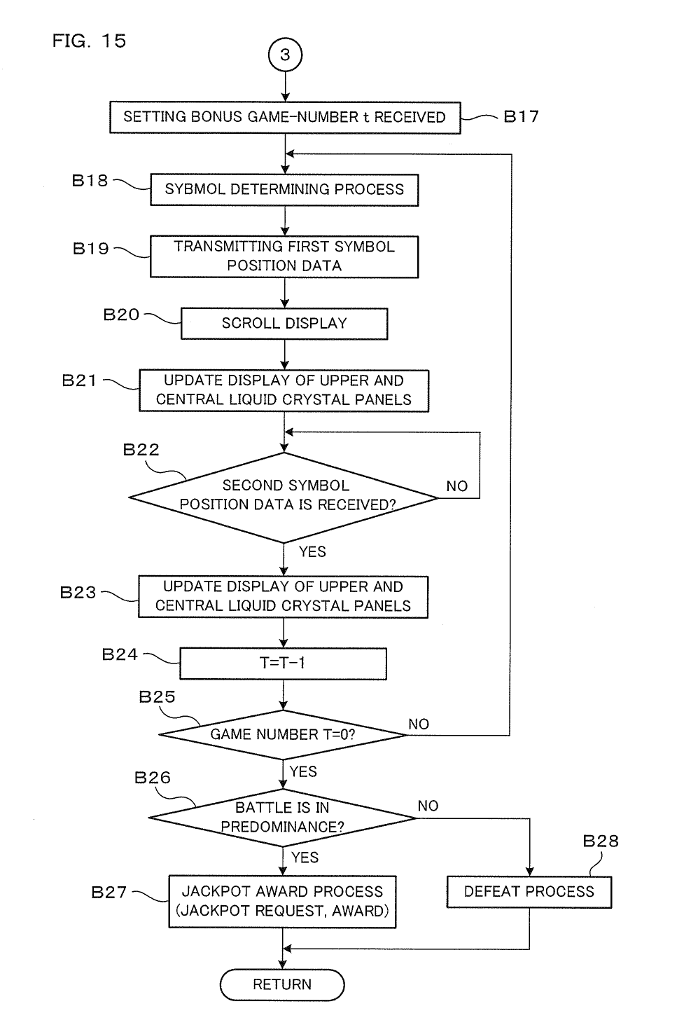

The main CPU 32 of the slot machine 1 executes a bonus game process routine shown in FIGS. 13 to 15, in a step of A10 when it is determined in the step of A9 in FIG. 12 that a bonus trigger is made. When a bonus game process routine is executed, a competition party search signal is firstly transmitted to the host computer 200 through the network 201 (B1). Then, it is determined whether the competition party information and the game-number t are received from the host computer 200 through the network 201 (B2). When it is determined that the competition party information and the game-number t are not received (B2, NO), it is determined whether a predetermined time has elapsed after transmitting the competition party search signal (B3). When it is determined that a predetermined time has not elapsed (B3, NO), it is returned to the step of B2. In the mean time, when it is determined that a predetermined time has elapsed (B3, YES), the main CPU 32 determines the bonus game-number T (B4).

Then, a symbol determining process is executed (B5). In other words, a stop symbol determining program stored in the RAM 33 is executed, so that a symbol matrix including 15 symbols 180 to be stopped is determined.

Then, the symbols 180 are scrolled in the display windows 151˜155 (B6). After the scroll of the symbols 180 is started and then a predetermined time (base time) has elapsed, the symbol matrix determined in the step of B5 is stopped (rearranged) in the display windows 151˜155.

Then, it is performed an update display of the upper liquid crystal panel 5A and the central liquid crystal panel 5B (B7). Specifically, the first area 191 and the second area 192, which correspond to the first symbol 181 and the second symbol 182 rearranged in the first display area 101B of the central liquid crystal panel 5B, are displayed in the second display area 101A of the central liquid crystal panel 5B and the second display area 101A of the upper liquid crystal panel 5A.

Then, it is determined whether a combination is made or not, i.e., whether a combination of the symbols 180 stopped in the display windows 151˜155 is a winning combination (B8). When it is determined that the combination is not a winning combination (B8, NO), the process is transited to the step of B12. Meantime, when it is determined that the combination is a winning combination (B8, YES), it is determined whether a prisoner's base is in advantageous state or not (B9). To be more specific, when the number of the first areas 191 displayed in the second display area 101A is larger than the number of the second areas 192, it is determined that a prisoner's base is in advantageous state. In the step of B9, when it is determined that a prisoner's base is in advantageous state (B9, YES), a payout is awarded in double (B11). In other words, it is calculated the payout-number that is two times more than the payout-number of coins based on a winning combination made. When the coins to be paid out are stored, the predetermined number of credits is added to a credit-number stored in the RAM 33. In the mean time, when the coins are paid out, a control signal is transmitted to the hopper 64, so that the predetermined number of coins is discharged to a coin receiving portion 19. Then, the process is transited to a step of B12.

Then, when it is determined in the step of B9 that a prisoner's base is not in advantageous state (B9, NO), a base payout process is executed (B10). In other words, it is calculated a payout-number of coins based on a winning combination made. Then, the process is transited to a step of B12.

When it is determined in the step of B8 that a combination is not made (B8, NO) and when the processes of B11 and B12 are performed, it is determined whether a bonus trigger is made as a winning combination (B12). In other words, it is determined whether three or more “SUN” are arranged in the display windows 151˜155. When it is determined that a bonus trigger is made (B12, YES), a game-number t to be added is determined (B13). Then, the game-number t is added to the bonus game-number T (B14).

In the mean time, when it is determined in the step of B12 that a bonus trigger is not made (B12, NO), or after the step of B14, the bonus game-number T is subtracted (B15). Then, it is determined whether the bonus game-number T is “0” (B16). When it is determined that the bonus game-number T is not “0” (B16, NO), the process is returned to the step of B5. In the mean time, when it is determined that the bonus game-number T is “0” (B16, YES), this sub-routine is ended.

When it is determined in the step of B2 that the competition party information and the game-number t are received (B2, YES), the bonus game-number t received is set (B17).

Then, a symbol determining process is performed (B18). Specifically, a symbol determining program stored in the RAM 33 is executed, so that a symbol matrix including 15 symbols 180 to be stopped is determined.

Then, the position data of the first symbol 181 determined is transmitted to the other slot machine that is the competition party through the network 201 (B19).

Then, the symbols 180 are scrolled in the display windows 151˜155 (B20). After the scroll of the symbols 180 is started and then a predetermined time (base time) has elapsed, the symbol matrix determined in the step of B18 is stopped (rearranged) in the display windows 151˜155.

Then, it is performed an update display of the upper liquid crystal panel 5A and the central liquid crystal panel 5B (B21). Specifically, the first area 191 and the second area 192, which correspond to the first symbol 181 and the second symbol 182 rearranged in the first display area 101B of the central liquid crystal panel 5B, are displayed in the second display area 101A of the central liquid crystal panel 5B and the second display area 101A of the upper liquid crystal panel 5A.

Then, it is determined whether the position data of the second symbol 182 is received from the other slot machine that is the competition party through the network 201 (B22). The determination process is repeated until it is determined that the position data is received (B22, NO). When it is determined that the position data of the second symbol 182 is received (B22, YES), it is performed an update display of the upper liquid crystal panel 5A and the central liquid crystal panel 5B, based on the position data of the second symbol 182 received (B7). Specifically, the first area 191 and the second area 192, which correspond to the first symbol 181 and the second symbol 182 rearranged in the first display area 101B of the central liquid crystal panel 5B, are displayed in the second display area 101A of the central liquid crystal panel 5B and the second display area 101A of the upper liquid crystal panel 5A.

Then, the bonus game-number T is subtracted by “1” (B24) Then, it is determined whether the bonus game-number is “0” (B25). When it is determined that the bonus game-number is not “0” (B25, NO), the process is returned to the step of B18. In the mean time, when it is determined that the bonus game-number is “0” (B25, YES), it is determined whether a prisoner's base ends in a victory (B26) To be more specific, when the number of the first areas 191 displayed in the second display area 101A is larger than the number of the second areas 192, it is determined that a prisoner's base ends in a victory. When it is determined that a prisoner's base ends in a victory (B26, YES), a jackpot award process is executed (B27) and this routine is ended. Specifically, a jackpot request signal is transmitted to the host computer 200 through the network 201, a jackpot data is received from the host computer 200 and a game value (payout) corresponding to the jackpot received is awarded. In the mean time, when it is determined in the step of B26 that a prisoner's base does not end in a victory (B26, NO), a defeat process is executed (B28) and this routine is ended. To be more specific, in a prisoner's base game, a defeat message is displayed to the competition party in the upper liquid crystal panel 5A.

Like this, when a predetermined condition is fulfilled, whenever the symbols are rearranged in the first display area, an operation of replacing an area, which is not the first area, with the first area, as an area corresponding to a position of the first symbol, and an operation of replacing an area, which is not the second area, with the second area, as an area corresponding to a position of the second symbol are alternately performed in the second display area. When a predetermined condition is fulfilled, whenever the symbols are rearranged in the first display area, an area, which is not the first area, is replaced with the first area, as an area corresponding to a position of the first symbol rearranged, a first symbol position data relating to a position of the first symbol rearranged is transmitted to the other slot machine, a second symbol position data relating to a position of the second symbol rearranged in the other slot machine is received from the other slot machine and an area, which is not the second area, is replaced with the second area, as an area corresponding to a position based on the second symbol position data, in the second display area. Then, a payout relating to a relation between the first area and the second area displayed is awarded at a specific timing. Thereby, it is visually recognized whether a payout is awarded or not by seeing the first area and second area displayed in the second area, so that a new entertainment characteristic can be provided.

(Process Operation of the Slot Machine 1: Sub Control Board 72)

When the various processes are performed by the game executing process routine in the main control board 71, a result or content corresponding to the process is inputted as a command or data to the sub control board 72. The sub control board 72 performs the display of the payout-number display unit 8 of the central liquid crystal panel 5B or credit-number display unit 9 and the like and displays an effect image in the upper liquid crystal panel 5A. In addition, the sub control board 72 performs an effect relating to an output of the sound from the speaker 23, in combination with, or independently of the effect in the upper liquid crystal panel 5A.

(Processing Operation of the Host Computer 200)

In the followings, a process that is performed in the host computer 200 will be described. When the CPU 211 reads out and executes a game program, a game is started.

(Server Processing)

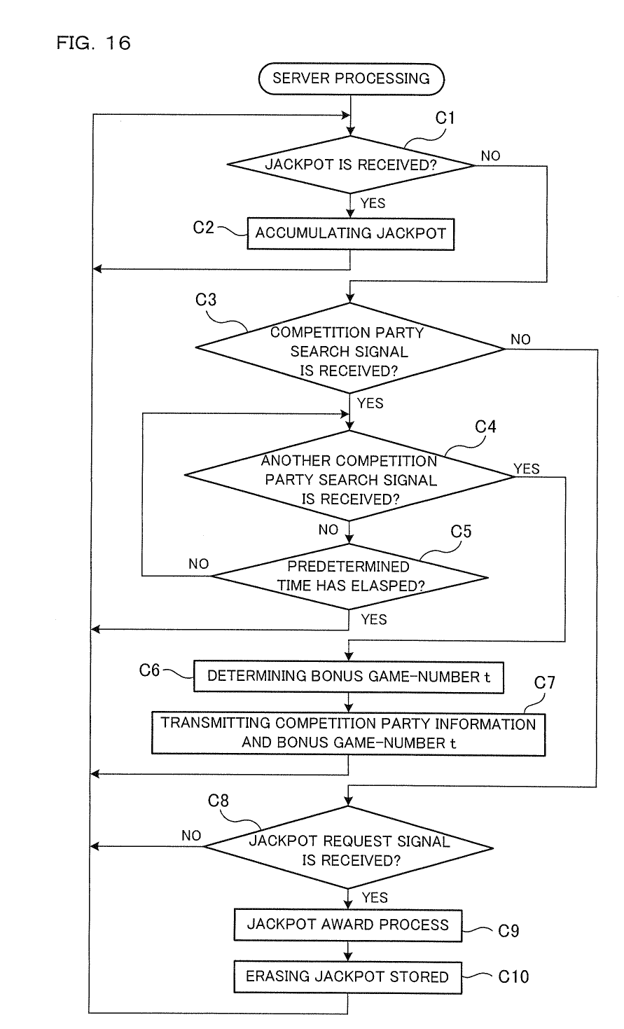

The CPU 211 of the host computer 200 executes a server processing routine shown in FIG. 16. When a server processing routine is executed, the CPU 211 firstly determines whether a jackpot is received from the slot machine 1 through the network 201 (C1). When it is determined that a jackpot is received (C1, YES), the CPU 211 accumulates the jackpot in the RAM 213 (C2) and returns to the step of C1. In the mean time, in the step of C1, when it is determined that a jackpot is not received (C1, NO), it is determined whether a competition party search signal is received from the slot machine 1 through the network 201 (C3) When it is determined that a competition party search signal is received (C3, YES), it is determined whether another competition search signal is received (C4). In the step of C4, when it is determined that another competition search signal is not received (C4, NO), it is determined whether a predetermined time has elapsed after the original competition party search signal has been received (C5). When it is determined that a predetermined time has not elapsed (C5, NO), the process is returned to the step of C4. In the mean time, when it is determined that a predetermined time has elapsed (C5, YES), the process is returned to the step of C1.

In the mean time, in the step of C4, when it is determined that another competition party search signal is received (C4, YES), a bonus game-number t is determined (C6), the competition party information and the bonus game-number t determined in the step of C6 are transmitted to the slot machine that transmitted the competition party search signal (C7) and the process is returned to the step of C1.

In the mean time, in the step of C3, when it is determined that a competition party search signal is not received (C3, NO), it is determined whether a jackpot request signal is received from the slot machine 1 through the network 201 (C8). When it is determined that a jackpot request signal is not received (C8, NO), the process is returned to the step of C1. Meantime, when it is determined that a jackpot request signal is received (C8, YES), a jackpot award process is performed (C9). Specifically, the jackpot, which is stored in the RAM 213, is transmitted to the slot machine 1 that transmitted the jackpot request signal, through the network 201. Then, the jackpot stored in the RAM 213 is erased (C10) and the process is returned to the step of C1.

Like this, a payout relating to a relation between the first area and the second area displayed is awarded at a specific timing (at the time of a bonus game). In other words, when the number of the first areas is larger than the number of the second areas, a jackpot is awarded as a payout. Thereby, it is visually recognized whether a payout is awarded or not by seeing the first area and second area displayed in the second area, so that a new entertainment characteristic can be provided. Meanwhile, although a jackpot is awarded as a payout when the number of the first areas is larger than the number of the second areas, the invention is not limited thereto as long as a payout is awarded in accordance with a relation between the first area and the second area.

Although the above descriptions have been provided with regard to the characteristic parts so as to understand the invention more easily, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be easily derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A slot machine comprising:
a first display area that arranges a plurality of symbols including a first symbol and a second symbol;
a second display area that displays a plurality of areas including a first area corresponding to the first symbol and a second area corresponding to the second symbol; and
a controller that operates:
(a1) to rearrange the symbols based on a predetermined timing;
(a2) to determine a winning by a relation of the symbols rearranged;
(a3) to alternately execute an operation of replacing an area, which is not the first area, with the first area, as an area corresponding to a position of the first symbol rearranged, and an operation of replacing an area, which is not the second area, with the second area, as an area corresponding to a position of the second symbol rearranged, whenever the symbols are rearranged; and
(a4) to award a prize relating to a relation between the first area and second area displayed, at a specific timing.

2. A slot machine comprising:
a first display area that arranges a plurality of symbols including a first symbol and a second symbol;
a second display area that displays a plurality of areas including a first area corresponding to the first symbol and a second area corresponding to the second symbol; and
a controller that operates:
(b1) to rearrange the symbols based on a predetermined timing;
(b2) to determine a winning by a relation of the symbols rearranged;
(b3) when a predetermined condition is fulfilled, to alternately execute an operation of replacing an area, which is not the first area, with the first area, as an area corresponding to a position of the first symbol rearranged, and an operation of replacing an area, which is not the second area, with the second area, as an area corresponding to a position of the second symbol rearranged, whenever the symbols are rearranged; and
(b4) to award a prize relating to a relation between the first area and second area displayed, at a specific timing.

3. A slot machine comprising:
a first display area that arranges a plurality of symbols including a first symbol and a second symbol;
a second display area that displays a plurality of areas including a first area corresponding to the first symbol and a second area corresponding to the second symbol;
a communication device that is in data-communication with the other slot machine; and
a controller that operates:
(c1) to rearrange the symbols based on a predetermined timing;
(c2) to determine a winning by a relation of the symbols rearranged;
(c3) to replace an area, which is not the first area, with the first area, as an area corresponding to a position of the first symbol rearranged, to transmit a first symbol position data relating to a position of the first symbol rearranged to the other slot machine, to receive from the other slot machine a second symbol position data relating to a position of the second symbol rearranged in the other slot machine and to replace an area, which is not the second area, with the second area, as an area corresponding to a position based on the second symbol position data, whenever the symbols are rearranged; and
(c4) to award a prize relating to a relation between the first area and second area displayed, at a specific timing.

4. A slot machine comprising:
a first display area that arranges a plurality of symbols including a first symbol and a second symbol;
a second display area that displays a plurality of areas including a first area corresponding to the first symbol and a second area corresponding to the second symbol;
a communication device that is in data-communication with the other slot machine; and
a controller that operates:
(d1) to rearrange the symbols based on a predetermined timing;
(d2) to determine a winning by a relation of the symbols rearranged;
(d3) when a predetermined condition is fulfilled, to replace an area, which is not the first area, with the first area, as an area corresponding to a position of the first symbol rearranged, to transmit a first symbol position data relating to a position of the first symbol rearranged to the other slot machine, to receive from the other slot machine a second symbol position data relating to a position of the second symbol rearranged in the other slot machine and to replace an area, which is not the second area, with the second area, as an area corresponding to a position based on the second symbol position data, whenever the symbols are rearranged; and
(d4) to award a prize relating to a relation between the first area and second area displayed, at a specific timing.

5. A playing method of a slot machine using a first display area that arranges a plurality of symbols including a first symbol and a second symbol; and a second display area that displays a plurality of areas including a first area corresponding to the first symbol and a second area corresponding to the second symbol, the playing method comprising the steps of:
(e1) rearranging the symbols based on a predetermined timing;
(e2) determining a winning by a relation of the symbols rearranged;
(e3) alternately executing an operation of replacing an area, which is not the first area, with the first area, as an area corresponding to a position of the first symbol rearranged, and an operation of replacing an area, which is not the second area, with the second area, as an area corresponding to a position of the second symbol rearranged, whenever the symbols are rearranged; and
(e4) awarding a payout relating to a relation between the first area and second area displayed, at a specific timing.
